(19) United States
(12) Patent Application Publication
(10) Pub. No.: US 2026/0213368 A1
(43) Pub. Date: Jul. 23, 2026

(54) CYLINDRICAL BATTERY AND ELECTRICAL DEVICE

(71) Applicant: XIAMEN AMPACE TECHNOLOGY LIMITED, Xiamen City (CN)

(72) Inventors: Shenzhao QIU, Xiamen City (CN); Ping HE, Xiamen City (CN)

(73) Assignee: XIAMEN AMPACE TECHNOLOGY LIMITED, Xiamen City (CN)

(21) Appl. No.: 19/570,819

(22) Filed: Mar. 18, 2026

Related U.S. Application Data
(63) Continuation of application No. PCT/CN2023/124705, filed on Oct. 16, 2023.

(30) Foreign Application Priority Data
Sep. 18, 2023 (WO) PCT/CN2023/119475

(51) Int. Cl. H01M 50/533; H01M 10/04; H01M 50/107; H01M 50/474

(52) U.S. Cl. CPC H01M 50/533; H01M 10/0431; H01M 50/107; H01M 50/474

(57) ABSTRACT

A cylindrical battery includes a housing, an electrode assembly in the housing, and a current collector plate. The electrode assembly is formed by stacking and winding a first electrode plate, a separator, and a second electrode plate. Along a winding direction of the electrode assembly, the first electrode plate includes a first part and a second part. The first part includes a winding start section of the first electrode plate. Along an axial direction of the cylindrical battery, an end face of the first part extends beyond an end face of the second part. The electrode assembly includes a main portion and a flattened portion arranged along the axial direction. The flattened portion is a portion by which the first part extends beyond the second part. The electrode assembly and the current collector plate are along the axial direction. The current collector plate is connected to the flattened portion.

### CROSS-REFERENCE TO RELATED APPLICATIONS

This application is a continuation application of International Application No. PCT/CN2023/124705, filed on Oct. 16, 2023, which claims the priority of International Application No. PCT/CN2023/119475, filed on Sep. 18, 2023, the contents of which are incorporated herein by reference in its entirety.

### TECHNICAL FIELD

This application relates to the technical field of energy storage, and in particular, to a cylindrical battery and an electrical device.

### BACKGROUND

In cylindrical batteries, an electrode plate in an electrode assembly is usually flattened at an end to facilitate connection to a current collector plate. The flattened part of the electrode plate takes up a lot of space, resulting in a relatively large length of the electrode assembly and affecting the energy density of the cylindrical battery.

### SUMMARY

In view of the above situation, it is necessary to provide a cylindrical battery to reduce the length of an electrode assembly in the battery and increase the energy density of the cylindrical battery.

An embodiment of this application provides a cylindrical battery. The cylindrical battery includes a housing, an electrode assembly disposed in the housing, and a current collector plate. The electrode assembly is formed by stacking and then winding a first electrode plate, a separator, and a second electrode plate. The separator is disposed between the first electrode plate and the second electrode plate. Along a winding direction of the electrode assembly, the first electrode plate includes a first part and a second part that are connected to each other. The first part includes a winding start section of the first electrode plate. Along an axial direction of the cylindrical battery, an end face of the first part extends beyond an end face of the second part. The electrode assembly includes a main portion and a flattened portion connected to each other. The main portion and the flattened portion are arranged along the axial direction. The flattened portion is a portion by which the first part extends beyond the second part. Along the axial direction, the flattened portion extends beyond the main portion. The electrode assembly and the current collector plate are arranged along the axial direction. The current collector plate is connected to the flattened portion. It is defined that a diameter of the main portion is D1 and a diameter of the flattened portion is D2, satisfying D2<D1.

In the above cylindrical battery, the first part of the first electrode plate extends beyond the second part along the axial direction. The portion by which the first part extends beyond the second part forms the flattened portion of the electrode assembly. The diameter D2 of the flattened portion is less than the diameter D1 of the main portion. Compared with an electrode assembly in which the diameter of the main portion is equal to the diameter of the flattened portion, the end portion of the electrode assembly in this application along the axial direction is smaller, thereby facilitating compression of the flattened portion, reducing the space occupied by the flattened region, and consequently reducing the length of the electrode assembly and increasing the energy density of the cylindrical battery. At the same time, the first part is located at the winding start section of the electrode assembly, thereby making the flattened portion more compact after being compressed, facilitating connection to the current collector plate, improving the flow capacity between the first electrode plate and the current collector plate, and reducing the temperature rise.

In some embodiments of this application, D1−D2≥3 mm, thereby compressing the flattened portion, reducing the length of the electrode assembly, increasing the energy density of the cylindrical battery, ensuring a sufficient connection area between the flattened portion and the current collector plate, and improving the flow capacity between the electrode assembly and the current collector plate.

In some embodiments of this application, 13 mm≤D2≤40 mm, thereby further ensuring a sufficient connection area between the flattened portion and the current collector plate, and further improving the flow capacity between the electrode assembly and the current collector plate.

In some embodiments of this application, the cylindrical battery further includes a first insulation piece. The first insulation piece is disposed in the housing. The main portion and the first insulation piece are arranged along the axial direction. Viewed along a direction opposite to the axial direction, the first insulation piece surrounds the flattened portion. Along a radial direction of the cylindrical battery, a projection of the first insulation piece overlaps a projection of the flattened portion. The first insulation piece not only serves a function of insulative protection to reduce short-circuit risks of the electrode assembly, but also serves a function of filling protection to reduce the risk of wobbling of the electrode assembly along the axial direction, thereby improving the safety performance of the cylindrical battery.

In some embodiments of this application, it is defined that a thickness of the first insulation piece along the axial direction is H, satisfying 0.2 mm≤H≤1 mm. This configuration is beneficial for the first insulation piece to serve the functions of insulation and filling protection, thereby improving the safety performance of the cylindrical battery. At the same time, this configuration avoids occupation of excessive space, and reduces the impact on the energy density of the cylindrical battery.

In some embodiments of this application, the first electrode plate includes a first current collector, a first insulation layer, and a first active layer. Both the first insulation layer and the first active layer are disposed on the same surface of the first current collector. The first active layer and the first insulation layer are arranged along the axial direction.

In some embodiments of this application, the first current collector includes a blank foil region. The first insulation layer and the first active layer are not disposed in the blank foil region. The first active layer, the first insulation layer, and the blank foil region are arranged along the axial direction. A part of the blank foil region is flattened to form the flattened portion, thereby facilitating connection between the first electrode plate and the current collector plate.

In some embodiments of this application, it is defined that a distance between an end face of the flattened portion and the first insulation layer along the axial direction is L1, satisfying 0.5 mm≤L1≤1 mm, thereby reducing the length of the electrode assembly along the axial direction and increasing the energy density of the cylindrical battery.

In some embodiments of this application, the first insulation layer is closer to the current collector plate than the first active layer. A part of the first insulation layer is located in the first part, and another part of the first insulation layer is located in the second part. The first insulation layer is located at an end portion of the second part along the axial direction, thereby covering and protecting against the burrs of the first current collector at the end portion of the second part, reducing the risk that the burrs pierce the separator, and improving the safety performance of the cylindrical battery.

In some embodiments of this application, it is defined that along the axial direction, a width of the first insulation layer in the first part is W1, and a width of the first insulation layer in the second part is W2, satisfying W1>W2.

In some embodiments of this application, the current collector plate includes a base portion and an extension portion connected to each other. The base portion and the extension portion are stacked along the axial direction. The base portion is connected to the flattened portion, and the extension portion is connected to an electrode post or a cover of the cylindrical battery. The current collector plate is designed as a two-layer structure, thereby reducing the height space occupied by the current collector plate and increasing the energy density of the cylindrical battery.

In some embodiments of this application, it is defined that a maximum length of the current collector plate along a radial direction of the cylindrical battery after being expanded is L2, satisfying 1.5≤L2/D1≤2, thereby reducing the number of layers of the current collector plate after being folded, reducing the height space occupied by the current collector plate, and increasing the energy density of the cylindrical battery.

In some embodiments of this application, along the axial direction, an end of the first part away from the current collector plate is referred to as a first end, and an end of the second part away from the current collector plate is referred to as a second end. Along a direction opposite to the axial direction, the first end does not extend beyond the second end.

An embodiment of this application further provides an electrical device. The electrical device includes the cylindrical battery disclosed in any one of the above embodiments.

In the above electrical device, the first part of the first electrode plate in the cylindrical battery extends beyond the second part along the axial direction. The portion by which the first part extends beyond the second part forms the flattened portion of the electrode assembly. The diameter D2 of the flattened portion is less than the diameter D1 of the main portion. Compared with an electrode assembly in which the diameter of the main portion is equal to the diameter of the flattened portion, the end portion of the electrode assembly in this application along the axial direction is smaller, thereby facilitating compression of the flattened portion, reducing the space occupied by the flattened region, and consequently reducing the length of the electrode assembly, increasing the energy density of the cylindrical battery, and reducing the impact caused by the energy density of the cylindrical battery on the electrical device.

### BRIEF DESCRIPTION OF DRAWINGS

FIG. 1 is a schematic structural diagram of a cylindrical battery according to an embodiment of this application;

FIG. 2 is a cross-sectional view of a cylindrical battery according to an embodiment of this application;

FIG. 3 is a schematic structural diagram of a first electrode plate in an unwound state according to an embodiment of this application;

FIG. 4 is a schematic structural diagram of an electrode assembly according to an embodiment of this application;

FIG. 5 is a front view of an electrode assembly according to an embodiment of this application;

FIG. 6 is a cross-sectional view of a partial structure of an electrode assembly according to an embodiment of this application;

FIG. 7 is an exploded view of a partial structure of a cylindrical battery according to an embodiment of this application;

FIG. 8 is a schematic structural diagram of a current collector plate in an expanded state according to an embodiment of this application;

FIG. 9 is a stereoscopic schematic structural diagram of a current collector plate in an expanded state according to an embodiment of this application;

FIG. 10 is a schematic structural diagram of a current collector plate in a folded state according to an embodiment of this application; and

FIG. 11 is a schematic structural diagram of an electrical device according to an embodiment of this application.

### LIST OF REFERENCE SIGNS

| | |
|---|---|
| cylindrical battery | 100 |
| housing | 10 |
| sidewall | 11 |
| bottom wall | 12 |
| electrode assembly | 20 |
| first electrode plate | 21 |
| first part | 211 |
| second part | 212 |
| first current collector | 214 |
| first insulation layer | 215 |
| first active layer | 216 |
| blank foil region | 217 |
| second electrode plate | 22 |
| second current collector | 221 |
| separator | 23 |
| main portion | 24 |
| flattened portion | 25 |
| end face | 251 |
| current collector plate | 30 |
| base portion | 31 |
| extension portion | 32 |
| fold line | 33 |
| cap | 40 |
| rupture disc | 50 |
| groove | 51 |
| orifice plate | 60 |
| through-hole | 61 |
| structural component | 70 |
| first insulation piece | 81 |
| second insulation piece | 82 |
| axial direction | X |
| electrical device | 200 |

This application is further described below with reference to the following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is noted that a component considered to be “connected to” another component may be directly connected to the other component or may be connected to the other component through an intermediate component. A component considered to be “disposed on” another component may be directly disposed on the other component or may be disposed on the other component through an intermediate component.

Unless otherwise defined, all technical and scientific terms used herein bear the same meanings as what is normally understood by a person skilled in the technical field of this application. The terms used in the specification of this application are merely intended to describe specific embodiments but not to limit this application.

An embodiment of this application provides a cylindrical battery. The cylindrical battery includes a housing, an electrode assembly disposed in the housing, and a current collector plate. The electrode assembly is formed by stacking and then winding a first electrode plate, a separator, and a second electrode plate. The separator is disposed between the first electrode plate and the second electrode plate. Along a winding direction of the electrode assembly, the first electrode plate includes a first part and a second part that are connected to each other. The first part includes a winding start section of the first electrode plate. Along an axial direction of the cylindrical battery, an end face of the first part extends beyond an end face of the second part. The electrode assembly includes a main portion and a flattened portion connected to each other. The main portion and the flattened portion are arranged along the axial direction. The flattened portion is a portion by which the first part extends beyond the second part. Along the axial direction, the flattened portion extends beyond the main portion. The electrode assembly and the current collector plate are arranged along the axial direction. The current collector plate is connected to the flattened portion. It is defined that a diameter of the main portion is D1 and a diameter of the flattened portion is D2, satisfying D2<D1.

In the above cylindrical battery, the first part of the first electrode plate extends beyond the second part along the axial direction. The portion by which the first part extends beyond the second part forms the flattened portion of the electrode assembly. The diameter D2 of the flattened portion is less than the diameter D1 of the main portion. Compared with an electrode assembly in which the diameter of the main portion is equal to the diameter of the flattened portion, the end portion of the electrode assembly in this application along the axial direction is smaller, thereby facilitating compression of the flattened portion, reducing the space occupied by the flattened region, and consequently reducing the length of the electrode assembly and increasing the energy density of the cylindrical battery. At the same time, the first part is located at the winding start section of the electrode assembly, thereby making the flattened portion more compact after being compressed, facilitating connection to the current collector plate, improving the flow capacity between the first electrode plate and the current collector plate, and reducing the temperature rise.

The following further describes the embodiments of this application with reference to drawings.

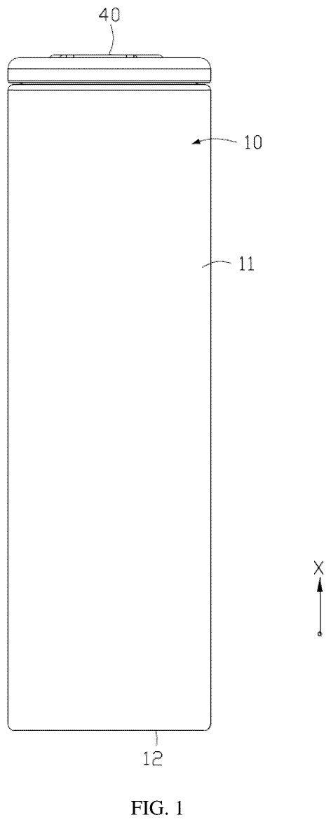

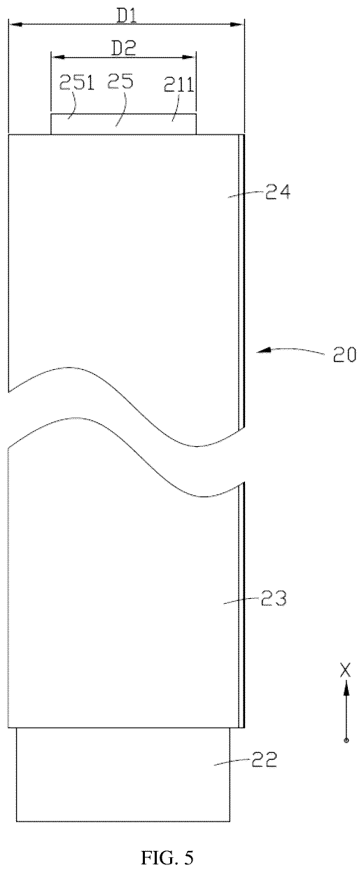

As shown in FIG. 1 to FIG. 5, an embodiment of this application provides a cylindrical battery 100, including a housing 10, an electrode assembly 20 disposed in the housing 10, and a current collector plate 30.

The electrode assembly 20 is formed by stacking and then winding a first electrode plate 21, a separator 23, and a second electrode plate 22. The separator 23 is disposed between the first electrode plate 21 and the second electrode plate 22. Along a winding direction of the electrode assembly 20, the first electrode plate 21 includes a first part 211 and a second part 212 that are connected to each other. The first part 211 includes a winding start section of the first electrode plate 21. Along an axial direction X of the cylindrical battery 100, an end face of the first part 211 extends beyond an end face of the second part 212. The winding start section of the first electrode 21 means a section of the first electrode plate 21 in a jelly-roll electrode assembly 20, where the section starts from the start end of the first electrode plate 21 and extends a distance along the winding direction of the electrode assembly 20.

The electrode assembly 20 includes a main portion 24 and a flattened portion 25 connected to each other. The main portion 24 and the flattened portion 25 are arranged along the axial direction X. The flattened portion 25 is a portion by which the first part 211 extends beyond the second part 212. Along the axial direction X, the flattened portion 25 extends beyond the main portion 24.

The electrode assembly 20 and the current collector plate 30 are arranged along the axial direction X. The current collector plate 30 is connected to the flattened portion 25. It is defined that a diameter of the main portion 24 is D1 and a diameter of the flattened portion 25 is D2, satisfying D2<D1.

In the above cylindrical battery 100, the first part 211 of the first electrode plate 21 extends beyond the second part 212 along the axial direction X. The portion by which the first part 211 extends beyond the second part 212 forms the flattened portion 25 of the electrode assembly 20. The diameter D2 of the flattened portion 25 is less than the diameter D1 of the main portion 24. Compared with an electrode assembly in which the diameter of the main portion is equal to the diameter of the flattened portion, the end portion of the electrode assembly 20 in this application along the axial direction X is smaller, thereby facilitating compression of the flattened portion 25, reducing the space occupied by the flattened region, and consequently reducing the length of the electrode assembly 20 and increasing the energy density of the cylindrical battery 100. At the same time, the first part 211 is located at the winding start section of the electrode assembly 20, thereby making the flattened portion 25 more compact after being compressed, facilitating connection to the current collector plate 30, improving the flow capacity between the first electrode plate 21 and the current collector plate 30, and reducing the temperature rise.

Here, the axial direction X means a direction toward the top of the cylindrical battery 100 along the central axis of the cylindrical battery 100.

In an embodiment, the housing 10 includes a sidewall 11 and a bottom wall 12. The bottom wall 12 and the sidewall 11 are arranged along the axial direction X, and are connected to each other to form a cylindrical accommodation cavity. The electrode assembly 20 and the current collector plate 30 are located in the accommodation cavity.

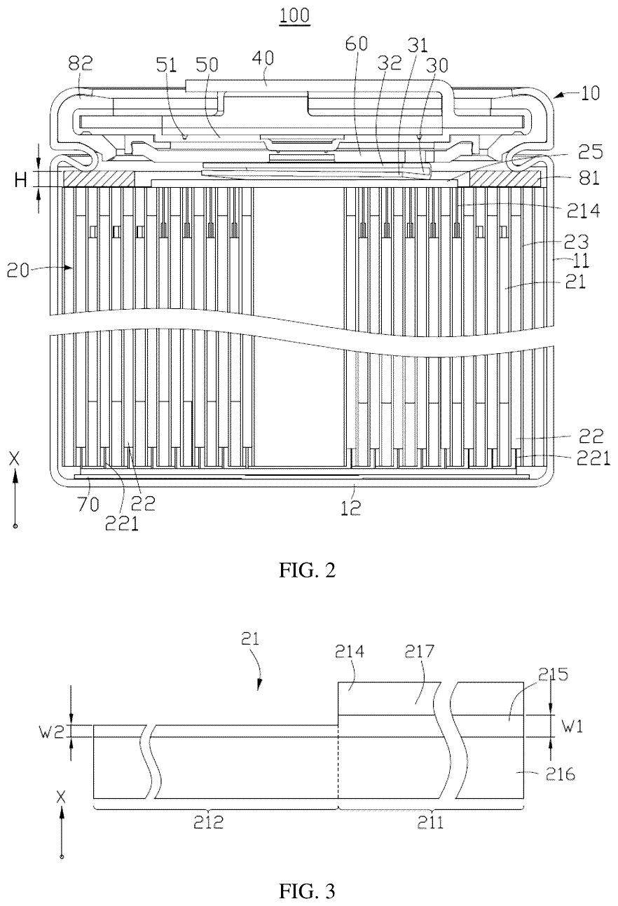

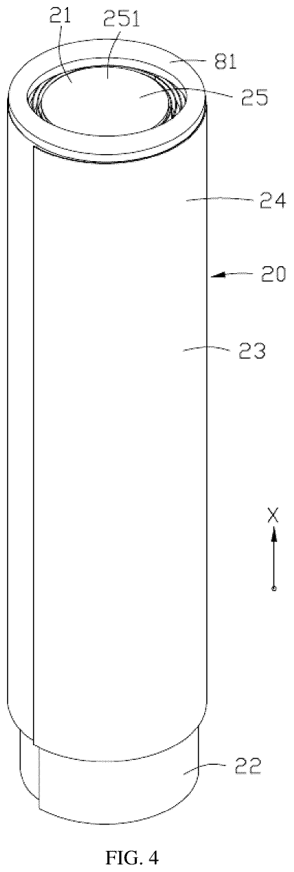

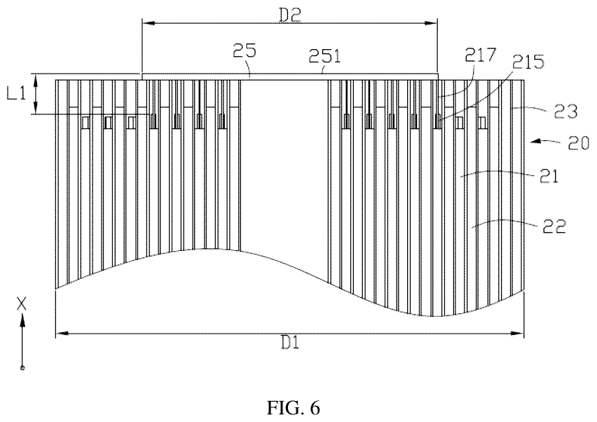

As shown in FIG. 2, FIG. 4, and FIG. 6, in an embodiment, of the first electrode plate 21 and the second electrode plate 22, one is a positive electrode plate, and the other is a negative electrode plate. Optionally, the first electrode plate 21 is a positive electrode plate, and the second electrode plate 22 is a negative electrode plate.

In an embodiment, along the axial direction X, a part of the separator 23 extends beyond the second electrode plate 22, and a part of the first part 211 extends beyond the separator 23. In an embodiment, the flattened portion 25 is a portion by which the first part 211 extends beyond the separator 23 along the axial direction X.

In an embodiment, a part of the separator 23 extends beyond the first electrode plate 21 along a direction opposite to the axial direction X, and a part of the second electrode plate 22 extends beyond the separator 23 and is connected to the bottom wall 12. In an embodiment, the second electrode plate 22 is electrically connected to the housing 10. The housing 10 serves as an output terminal of the cylindrical battery 100.

In an embodiment, the cylindrical battery 100 further includes a structural component 70. The structural component 70 is disposed in the housing 10. Along the axial direction X, the bottom wall 12, the structural component 70, and the electrode assembly 20 are arranged in sequence. The structural component 70 connects the bottom wall 12 and the second electrode plate 22 so that the second electrode plate 22 is electrically connected to the housing 10.

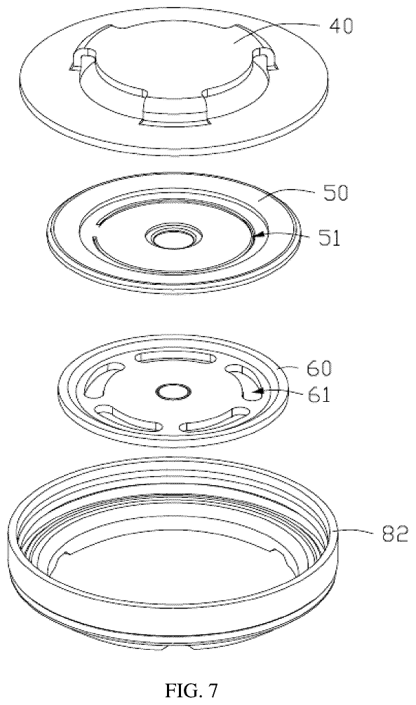

As shown in FIG. 2, FIG. 4, and FIG. 7, in an embodiment, the cylindrical battery 100 further includes a cap 40. The current collector plate 30 and the cap 40 are arranged along the axial direction X. The current collector plate 30 is connected to the cap 40. The first electrode plate 21 is electrically connected to the cap 40. The cap 40 serves as an output terminal of the cylindrical battery 100. In an embodiment, the cap 40 may serve as a positive electrode terminal of the cylindrical battery 100, and the housing 10 may serve as a negative electrode terminal of the cylindrical battery 100.

In an embodiment, the cylindrical battery 100 further includes a orifice plate 60 and a rupture disc 50. The current collector plate 30, the orifice plate 60, the rupture disc 50, and the cap 40 are arranged along the axial direction X. The current collector plate 30 is connected to the orifice plate 60. The rupture disc 50 is connected to the orifice plate 60 and the cap 40 so that the first electrode plate 21 is electrically connected to the cap 40.

In an embodiment, the cylindrical battery 100 further includes a second insulation piece 82. The second insulation piece 82 is connected to the sidewall 11 and the rupture disc 50. The second insulation piece 82 serves an insulation function, and reduces the short-circuit risk of the cylindrical battery 100. In an embodiment, the second insulation piece 82 is connected to the sidewall 11 and the orifice plate 60, thereby further reducing the short-circuit risk of the cylindrical battery 100.

In an embodiment, the second insulation piece 82 is made of plastic, thereby ensuring a good insulation effect of the insulation piece, reducing the weight of the insulation piece, and reducing the impact of the weight on the cylindrical battery 100.

In an embodiment, the second insulation piece 82 is formed by melting and curing plastic through injection molding equipment, thereby simplifying the manufacturing process of the second insulation piece 82, improving the manufacturing efficiency of the second insulation piece 82, and reducing cost.

In an embodiment, the material of the second insulation piece 82 includes, but is not limited to, any one of silicone, rubber, polypropylene (PP for short), or polyethylene terephthalate (PET for short).

In an embodiment, the rupture disc 50 is provided with a groove 51. The groove 51 is recessed in a direction opposite to the axial direction X. The region of the groove 51 constitutes a fragile region of the rupture disc 50. The orifice plate 60 is provided with a through-hole 61. The through-hole 61 allows an electrolyte solution or gas to pass through.

In an embodiment, when the gas pressure inside the cylindrical battery 100 increases, the gas can act on the rupture disc 50 through the through-hole 61. When the gas pressure increases to a pressure resistance threshold of the fragile region of the rupture disc 50, the gas inside the housing 10 can burst the rupture disc 50 to achieve the purpose of pressure relief, reduce the explosion risk of the cylindrical battery 100, and improve the safety performance of the cylindrical battery 100.

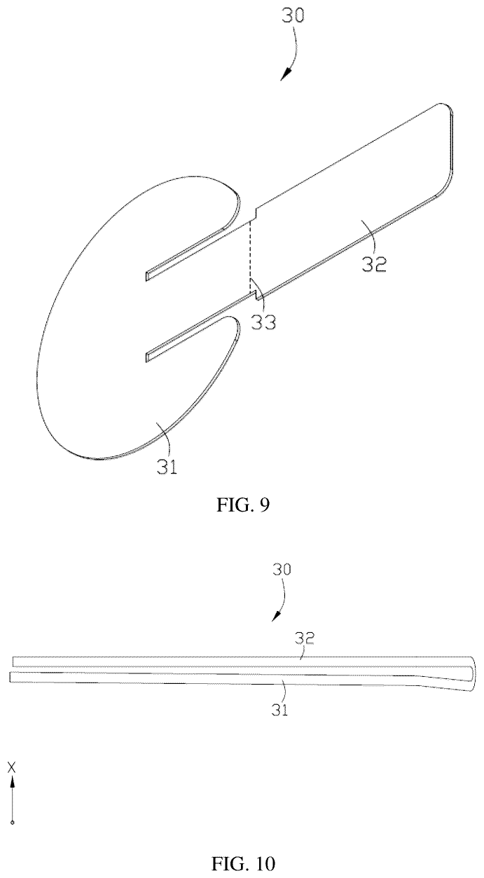

As shown in FIG. 2 to FIG. 5 and FIG. 8 to FIG. 10, in an embodiment, the current collector plate 30 includes a base portion 31 and an extension portion 32 connected to each other. The base portion 31 and the extension portion 32 are stacked along the axial direction X. The base portion 31 is connected to the flattened portion 25, and the extension portion 32 is connected to the orifice plate 60. The current collector plate 30 is designed as a two-layer structure, thereby reducing the height space occupied by the current collector plate and increasing the energy density of the cylindrical battery 100.

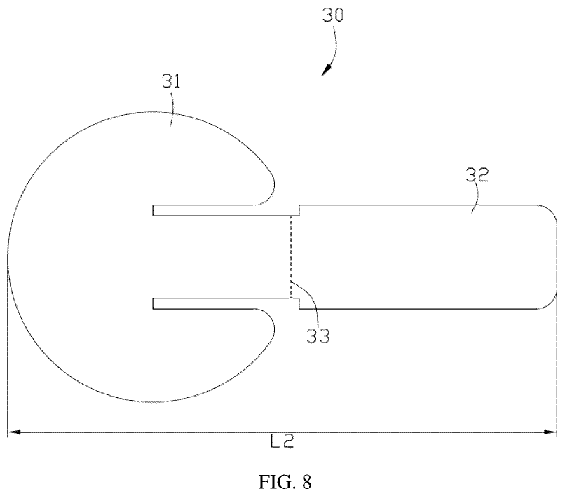

In an embodiment, the current collector plate 30 is initially in an expanded state (as shown in FIG. 8). During the assembling of the cylindrical battery 100, the current collector plate 30 is folded along the fold line 33 to form a two-layer structure (as shown in FIG. 10), and the base portion 31 and the extension portion 32 are stacked.

In an embodiment, it is defined that a maximum length of the current collector plate 30 along the radial direction of the cylindrical battery 100 in an expanded state is L2, satisfying 1.5≤L2/D1≤2, thereby reducing the number of layers of the current collector plate 30 after being folded, reducing the height space occupied by the current collector plate, and increasing the energy density of the cylindrical battery 100.

In an embodiment, the flattened portion 25 is welded to the current collector plate 30, thereby improving the connection stability between the first electrode plate 21 and the current collector plate 30, improving the flow capacity between the first electrode plate 21 and the current collector plate 30, and reducing the temperature rise.

In an embodiment, the current collector plate 30 is separate from the sidewall 11 along the radial direction of the cylindrical battery 100, thereby reducing the short-circuit risk of the cylindrical battery 100 and improving the safety performance of the battery.

In an embodiment, during assembling of the cylindrical battery 100, the base portion 31 is welded to the flattened portion 25, and then the current collector plate 30 is folded along the fold line 33 to stack up the base portion 31 and the extension portion 32. The current collector plate 30 and the electrode assembly 20 are placed into the housing 10, and the current collector plate 30 is pressed in a direction opposite to the axial direction X to compress the space occupied by the flattened portion 25. Subsequently, the orifice plate 60, the rupture disc 50, and other structures are connected.

As shown in FIG. 2 to FIG. 6, in an embodiment, D1−D2≥3 mm, thereby compressing the flattened portion 25, reducing the length of the electrode assembly 20 along the axial direction X, increasing the energy density of the cylindrical battery 100, ensuring a sufficient connection area between the flattened portion 25 and the current collector plate 30, improving the flow capacity between the electrode assembly 20 and the current collector plate 30, and reducing the temperature rise.

In an embodiment, 13 mm≤D2≤40 mm, thereby further ensuring a sufficient connection area between the flattened portion 25 and the current collector plate 30, and further improving the flow capacity between the electrode assembly 20 and the current collector plate 30.

In an embodiment, the diameter D2 of the flattened portion 25 is any one of 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, and 40 mm, thereby ensuring a sufficient connection area between the flattened portion 25 and the current collector plate 30, and improving the flow capacity between the electrode assembly plate 20 and the current collector plate 30.

In an embodiment, the first electrode plate 21 includes a first current collector 214, a first insulation layer 215, and a first active layer 216. Both the first insulation layer 215 and the first active layer 216 are disposed on the same surface of the first current collector 214. The first active layer 216 and the first insulation layer 215 are arranged along the axial direction X.

In an embodiment, the first active layer 216 is disposed on two surfaces of the first current collector 214 on two sides. In an embodiment, the first insulation layer 215 is disposed on two surfaces of the first current collector 214 on two sides.

In an embodiment, the first current collector 214 further includes a blank foil region 217. The first insulation layer 215 and the first active layer 216 are not disposed in the blank foil region 217. The first active layer 216, the first insulation layer 215, and the blank foil region 217 are arranged along the axial direction X. In an embodiment, an end portion of the blank foil region 217 along the axial direction X is flattened to form a flattened portion 25.

In an embodiment, the first insulation layer 215 is separate from the flattened portion 25 along the axial direction X. It is defined that a distance between an end face 251 of the flattened portion 25 and the first insulation layer 215 is L1, satisfying 0.5 mm≤L1≤1 mm, thereby reducing the length of the electrode assembly 20 along the axial direction X and increasing the energy density of the cylindrical battery 100.

In an embodiment, L is any one of 0.5 mm, 0.6 mm, 0.7 mm, 0.8 mm, 0.9 mm and 1 mm, thereby reducing the length of the electrode assembly 20 along the axial direction X and increasing the energy density of the cylindrical battery 100.

In an embodiment, along the axial direction X, the first insulation layer 215 is closer to the current collector plate 30 than the first active layer 216. A part of the first insulation layer 215 is located in the first part 211, and another part of the first insulation layer 215 is located in the second part 212.

In an embodiment, in a preparation process, the first electrode plate 21 is cut to form a first part 211 and a second part 212, so that the end portion of the second part 212 along the axial direction X includes a first insulation layer 215. The first insulation layer 215 can cover and protect against the burrs generated by the cutting at the end portion of the second part 212, reduce the risk of the burrs piercing the separator 23, and improve the safety performance of the cylindrical battery 100.

In an embodiment, a part of the first insulation layer 215 is located in the main portion 24, and another part of the first insulation layer 215 is located in the flattened portion 25.

In an embodiment, it is defined that along the axial direction X, the width of the first insulation layer 215 in the first part 211 is W1, and the width of the first insulation layer 215 in the second part 212 is W2, satisfying W1>W2.

In an embodiment, along a direction opposite to the axial direction X, an end of the first part 211 away from the current collector plate 30 is referred to as a first end, and an end of the second part 212 away from the current collector plate 30 is referred to as a second end. The first end does not exceed the second end.

In an embodiment, the first end is flush with the second end.

In an embodiment, the second electrode plate 22 includes a second current collector 221 and a second active layer (not shown in the figure). The second active layer is disposed on a surface of the second current collector 221. In an embodiment, the second active layer is not disposed at the end portion of the second current collector 221 along a direction opposite to the axial direction X. The end portion of the second current collector 221 is connected to a structural component 70, thereby implementing electrical connection between the second electrode plate 22 and the structural component 70.

In an embodiment, the end portion of the second current collector 221 is welded to the structural component 70, thereby improving the connection stability between the second electrode plate 22 and the structural component 70, improving the shock resistance of the cylindrical battery 100, improving the flow capacity between the second electrode plate 22 and the structural component 70, and reducing the temperature rise.

In an embodiment, the structural component 70 is welded to the bottom wall 12, thereby improving the connection stability between the bottom wall 12 and the structural component 70, improving the shock resistance of the cylindrical battery 100, improving the flow capacity between the bottom wall 12 and the structural component 70, and reducing the temperature rise.

In an embodiment, the second active layer is disposed on two surfaces of the second current collector 221 on two sides.

In an embodiment, the cylindrical battery 100 further includes a first insulation piece 81. The first insulation piece 81 is disposed in the housing 10. The main portion 24 and the first insulation piece 81 are arranged along the axial direction X. The first insulation piece 81 serves a function of filling protection to reduce the risk of wobbling of the electrode assembly 20 along the axial direction X, thereby improving the safety performance of the cylindrical battery 100.

In an embodiment, viewed along a direction opposite to the axial direction X, the first insulation piece 81 surrounds the flattened portion 25. Along a radial direction of the cylindrical battery 100, a projection of the first insulation piece 81 overlaps a projection of the flattened portion 25. The first insulation piece 81 provides insulative protection for the flattened portion 25, and reduces the short-circuit risk of the electrode assembly 20.

In an embodiment, it is defined that the thickness of the first insulation piece 81 along the axial direction X is H, satisfying 0.2 mm≤H≤1 mm. This configuration is beneficial for the first insulation piece 81 to serve the functions of insulation and filling protection, thereby improving the safety performance of the cylindrical battery 100. At the same time, this configuration avoids occupation of excessive space, and reduces the impact on the energy density of the cylindrical battery 100.

In an embodiment, the thickness H of the first insulation piece 81 is any one of 0.2 mm, 0.3 mm, 0.4 mm, 0.5 mm, 0.6 mm, 0.7 mm, 0.8 mm, 0.9 mm, or 1 mm. This configuration is beneficial for the first insulation piece 81 to serve the functions of insulation and filling protection, thereby improving the safety performance of the cylindrical battery 100. This configuration also reduces the space occupied by the first insulation piece, and reduces the impact on the energy density of the cylindrical battery 100.

In an embodiment, the first insulation piece 81 is made of plastic, thereby ensuring a good insulation and buffering effect of the insulation piece, reducing the weight of the insulation piece, and reducing the impact of the weight on the cylindrical battery 100.

In an embodiment, the first insulation piece 81 is formed by melting and curing plastic through injection molding equipment, thereby simplifying the manufacturing process of the first insulation piece 81, improving the manufacturing efficiency of the first insulation piece 81, and reducing cost.

In an embodiment, the material of the first insulation piece 81 includes, but is not limited to, any one of silicone, rubber, polypropylene (PP for short), or polyethylene terephthalate (PET for short).

To sum up, in the cylindrical battery 100 of this application, the first part 211 of the first electrode plate 21 extends beyond the second part 212 along the axial direction X. The portion by which the first part 211 extends beyond the second part 212 forms the flattened portion 25 of the electrode assembly 20. The diameter D2 of the flattened portion 25 is less than the diameter D1 of the main portion 24. Compared with an electrode assembly 20 in which the diameter of the main portion 24 is equal to the diameter of the flattened portion 25, the end portion of the electrode assembly 20 in this application along the axial direction X is smaller, thereby facilitating compression of the flattened portion 25, reducing the space occupied by the flattened region, and consequently reducing the length of the electrode assembly 20 and increasing the energy density of the cylindrical battery 100. At the same time, the first part 211 is located at the winding start section of the electrode assembly 20, thereby making the flattened portion 25 more compact after being compressed, facilitating connection to the current collector plate 30, improving the flow capacity between the first electrode plate 21 and the current collector plate 30, and reducing the temperature rise.

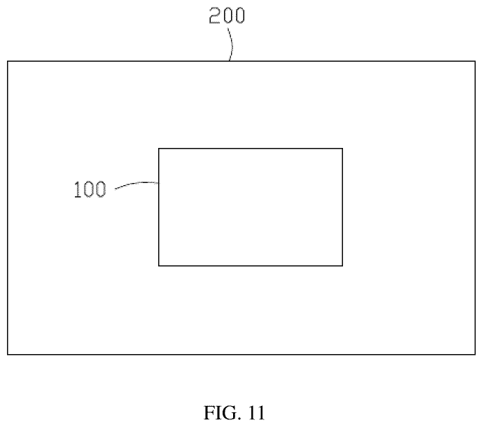

As shown in FIG. 11, an embodiment of this application further provides an electrical device 200, including the cylindrical battery 100 disclosed in any one of the embodiments described above.

In the above electrical device 200, the first part 211 of the first electrode plate 21 in the cylindrical battery 100 extends beyond the second part 212 along the axial direction X. The portion by which the first part 211 extends beyond the second part 212 forms the flattened portion 25 of the electrode assembly 20. The diameter D2 of the flattened portion 25 is less than the diameter D1 of the main portion 24. Compared with an electrode assembly 20 in which the diameter of the main portion 24 is equal to the diameter of the flattened portion 25, the end portion of the electrode assembly 20 in this application along the axial direction X is smaller, thereby facilitating compression of the flattened portion 25, reducing the space occupied by the flattened region, and consequently reducing the length of the electrode assembly 20, increasing the energy density of the cylindrical battery 100, and reducing the impact caused by the energy density of the cylindrical battery 100 on the electrical device 200.

In an embodiment, the electrical device 200 includes, but is not limited to, any one of an electric vehicle, an electric two-wheeler, an unmanned aerial vehicle, a household appliance, or consumer electronics.

In addition, a person skilled in the art may make other variations to this application without departing from the essence of this application. The variations made based on the essence of this application still fall within the protection scope of this application.

What is claimed is:

1. A cylindrical battery, comprising a housing, an electrode assembly disposed in the housing, and a current collector plate;
the electrode assembly is formed by stacking and then winding a first electrode plate, a separator, and a second electrode plate; the separator is disposed between the first electrode plate and the second electrode plate; along a winding direction of the electrode assembly, the first electrode plate comprises a first part and a second part connected to the first part; the first part comprises a winding start section of the first electrode plate; along an axial direction of the cylindrical battery, an end face of the first part extends beyond an end face of the second part;
the electrode assembly comprises a main portion and a flattened portion connected to the main portion; the main portion and the flattened portion are arranged along the axial direction;
the flattened portion is a portion of the first part by which the first part extends beyond the second part; and along the axial direction, the flattened portion extends beyond the main portion;
the electrode assembly and the current collector plate are arranged along the axial direction, and the current collector plate is connected to the flattened portion; and
a diameter of the main portion is D1 and a diameter of the flattened portion is D2, D2<D1.

2. The cylindrical battery according to claim 1, wherein D1−D2≥3 mm.

3. The cylindrical battery according to claim 1, wherein 13 mm≤D2≤40 mm.

4. The cylindrical battery according to claim 1, wherein
the cylindrical battery further comprises a first insulation piece, the first insulation piece is disposed in the housing, and the main portion and the first insulation piece are arranged along the axial direction;
viewed along a direction opposite to the axial direction, the first insulation piece surrounds the flattened portion; and
along a radial direction of the cylindrical battery, a projection of the first insulation piece overlaps a projection of the flattened portion.

5. The cylindrical battery according to claim 4, wherein a thickness of the first insulation piece along the axial direction is H, and 0.2 mm≤H≤1 mm.

6. The cylindrical battery according to claim 1, wherein
the first electrode plate comprises a first current collector, a first insulation layer, and a first active layer; and both the first insulation layer and the first active layer are disposed on a same surface of the first current collector;
the first current collector comprises a blank foil region; the first insulation layer and the first active layer are not disposed in the blank foil region; and the first active layer, the first insulation layer, and the blank foil region are arranged along the axial direction;
a part of the blank foil region is flattened to form the flattened portion; and
a distance between an end face of the flattened portion and the first insulation layer along the axial direction is L1, wherein 0.5 mm≤L1≤1 mm.

7. The cylindrical battery according to claim 1, wherein
the first electrode plate comprises a first current collector, a first insulation layer, and a first active layer; both the first insulation layer and the first active layer are disposed on a same surface of the first current collector; the first active layer and the first insulation layer are arranged along the axial direction; and the first insulation layer is closer to the current collector plate than the first active layer; and
a part of the first insulation layer is located in the first part, and another part of the first insulation layer is located in the second part.

8. The cylindrical battery according to claim 7, wherein along the axial direction, a width of the first insulation layer in the first part is W1, and a width of the first insulation layer in the second part is W2, W1>W2.

9. The cylindrical battery according to claim 1, wherein the current collector plate comprises a base portion and an extension portion connected to each other, the base portion and the extension portion are stacked along the axial direction, the base portion is connected to the flattened portion, and the extension portion is connected to an electrode post or a cover of the cylindrical battery.

10. The cylindrical battery according to claim 9, wherein along a radial direction of the cylindrical battery, a maximum length of the current collector plate is L2, 1.5≤L2/D1≤2.

11. An electrical device comprising a cylindrical battery, wherein the cylindrical battery comprises a housing, an electrode assembly disposed in the housing, and a current collector plate;
the electrode assembly is formed by stacking and then winding a first electrode plate, a separator, and a second electrode plate; the separator is disposed between the first electrode plate and the second electrode plate; along a winding direction of the electrode assembly, the first electrode plate comprises a first part and a second part connected to the first part; the first part comprises a winding start section of the first electrode plate; along an axial direction of the cylindrical battery, an end face of the first part extends beyond an end face of the second part;
the electrode assembly comprises a main portion and a flattened portion connected to the main portion; the main portion and the flattened portion are arranged along the axial direction;
the flattened portion is a portion of the first part by which the first part extends beyond the second part; and along the axial direction, the flattened portion extends beyond the main portion;
the electrode assembly and the current collector plate are arranged along the axial direction, and the current collector plate is connected to the flattened portion; and
a diameter of the main portion is D1 and a diameter of the flattened portion is D2, D2<D1.

12. The electrical device according to claim 11, wherein D1−D2≥3 mm.

13. The electrical device according to claim 11, wherein 13 mm≤D2≤40 mm.

14. The electrical device according to claim 11, wherein
the cylindrical battery further comprises a first insulation piece, the first insulation piece is disposed in the housing, and the main portion and the first insulation piece are arranged along the axial direction;
viewed along a direction opposite to the axial direction, the first insulation piece surrounds the flattened portion; and
along a radial direction of the cylindrical battery, a projection of the first insulation piece overlaps a projection of the flattened portion.

15. The electrical device according to claim 14, wherein a thickness of the first insulation piece along the axial direction is H, and 0.2 mm≤H≤1 mm.

16. The electrical device according to claim 11, wherein
the first electrode plate comprises a first current collector, a first insulation layer, and a first active layer; and both the first insulation layer and the first active layer are disposed on a same surface of the first current collector;
the first current collector comprises a blank foil region; the first insulation layer and the first active layer are not disposed in the blank foil region; and the first active layer, the first insulation layer, and the blank foil region are arranged along the axial direction;
a part of the blank foil region is flattened to form the flattened portion; and
a distance between an end face of the flattened portion and the first insulation layer along the axial direction is L1, wherein 0.5 mm≤L1≤1 mm.

17. The electrical device according to claim 11, wherein
the first electrode plate comprises a first current collector, a first insulation layer, and a first active layer; both the first insulation layer and the first active layer are disposed on a same surface of the first current collector; the first active layer and the first insulation layer are arranged along the axial direction; and the first insulation layer is closer to the current collector plate than the first active layer; and
a part of the first insulation layer is located in the first part, and another part of the first insulation layer is located in the second part.

18. The electrical device according to claim 17, wherein along the axial direction, a width of the first insulation layer in the first part is W1, and a width of the first insulation layer in the second part is W2, W1>W2.

19. The electrical device according to claim 11, wherein the current collector plate comprises a base portion and an extension portion connected to each other, the base portion and the extension portion are stacked along the axial direction, the base portion is connected to the flattened portion, and the extension portion is connected to an electrode post or a cover of the cylindrical battery.

20. The electrical device according to claim 19, wherein along a radial direction of the cylindrical battery, a maximum length of the current collector plate is L2, 1.5≤L2/D1≤2.
